(19) United States
(12) Patent Application Publication
(10) Pub. No.: US 2021/0238414 A1
(43) Pub. Date: Aug. 5, 2021

(54) THREE-DIMENSIONAL PRINTING

(71) Applicant: Hewlett-Packard Development Company, L.P., Spring, TX (US)

(72) Inventors: Shannon Reuben Woodruff, San Diego, CA (US); Stephen G. Rudisill, San Diego, CA (US); Erica Fung, San Diego, CA (US); Rachael Donovan, San Diego, CA (US)

(73) Assignee: Hewlett-Packard Development Company, L.P., Spring, TX (US)

(21) Appl. No.: 17/046,863

(22) PCT Filed: Oct. 24, 2018
(86) PCT No.: PCT/US2018/057362

§ 371 Date: Oct. 12, 2020

(51) Int. Cl. C08L 77/06

(52) U.S. Cl. CPC C08L 77/06

(57) ABSTRACT

In an example of a build material composition for three-dimensional (3D) printing, the build material composition includes a polyamide and a plasticizer. The plasticizer has formula (I): wherein n is an integer ranging from 3 to 8; or formula (II): wherein m is an integer ranging from 3 to 8.

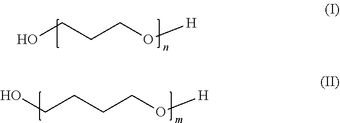

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for 3D printing;

FIG. 2 is a graphic illustration of one example of the method for 3D printing;

FIG. 3 is a cross-sectional view of an example 3D object;

FIG. 4 is a cross-sectional view of another example 3D object;

FIG. 5 is a graph showing the ultimate tensile strength, the elongation at break, and the Young's Modulus of 3D objects that were formed with example and control build material compositions, with the ultimate tensile strength (in MPa, right y-axis), the elongation at break (in %, left y-axis), and the Young's Modulus (in MPa, left y-axis) shown on the y-axes, and the 3D objects identified by the build material composition used to form the 3D objects on the x-axis; and

FIG. 6 is a graph showing the ultimate tensile strength, the elongation at break, and the Young's Modulus of 3D objects that were formed with control, example and comparative example build material compositions, with the ultimate tensile strength (in MPa, right y-axis), the elongation at break (in %, left y-axis), and the Young's Modulus (in MPa, left y-axis) shown on the y-axes, and the 3D objects identified by the build material composition used to form the 3D objects on the x-axis.

### DETAILED DESCRIPTION

The build material composition disclosed herein includes a polyamide and a particular plasticizer. With the plasticizer integrated directly into the build material composition, entire parts/objects can be fabricated with desirable and relatively uniform mechanical properties, without having to dispense different agents in order to achieve these properties. Moreover, the build material composition disclosed herein may be suitable for use in a variety of three-dimensional printing methods.

Some examples of three-dimensional (3D) printing disclosed herein may utilize a fusing agent (including an energy absorber) to pattern the build material composition. In these examples, an entire layer of the build material composition is exposed to radiation, but the patterned region (which, in some instances, is less than the entire layer) of the polymeric build material is coalesced/fused and hardened to become a layer of a 3D object. In the patterned region, the fusing agent is capable of at least partially penetrating into voids between the build material particles, and is also capable of spreading onto the exterior surface of the build material particles. This fusing agent is capable of absorbing radiation and converting the absorbed radiation to thermal energy, which in turn coalesces/fuses the polymeric build material that is in contact with the fusing agent.

Other examples of 3D printing disclosed herein may utilize selective laser sintering (SLS) or selective laser melting (SLM). During selective laser sintering or melting, a laser beam is aimed at a selected region (which, in some instances, is less than the entire layer) of a layer of the build material composition. Heat from the laser beam causes the build material composition under the laser beam to fuse.

Coalescing/fusing (through the use of (i) the fusing agent and radiation exposure, or (ii) the laser beam) causes the build material composition to join or blend to form a single entity (i.e., the layer of the 3D object). Coalescing/fusing may involve at least partial thermal merging, melting, binding, and/or some other mechanism that coalesces the polymeric build material to form the layer of the 3D object.

Throughout this disclosure, a weight percentage that is referred to as “wt % active” refers to the loading of an active component of a dispersion or other formulation that is present in the fusing agent, the detailing agent, and/or the coloring agent. For example, an energy absorber, such as carbon black, may be present in a water-based formulation (e.g., a stock solution or dispersion) before being incorporated into the fusing liquid. In this example, the wt % active of the carbon black accounts for the loading (as a weight percent) of the carbon black solids that are present in the fusing agent, and does not account for the weight of the other components (e.g., water, etc.) that are present in the stock solution or dispersion with the carbon black. The term “wt %,” without the term actives, refers to either i) the loading (in the fusing agent, the detailing agent, or the coloring agent) of a 100% active component that does not include other non-active components therein, or ii) the loading (in the fusing agent, the detailing agent, or the coloring agent) of a material or component that is used “as is” and thus the wt % accounts for both active and non-active components.

Build Material Compositions

Disclosed herein is a build material composition that includes a polyamide and a particular plasticizer. When the build material composition is used in a 3D printing process, the plasticizer may impart ductility to the 3D object formed by plasticizing the polyamide (i.e., decreasing the attraction between polymer chains of the polyamide).

In an example, the build material composition, comprises a polyamide; and a plasticizer having: a formula (I):

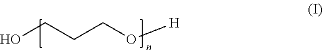

wherein n is an integer ranging from 3 to 8; or a formula (II):

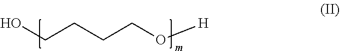

wherein m is an integer ranging from 3 to 8.

The polyamide may be any polyamide. In an example, the polyamide is selected from the group consisting of polyamide 6 (PA 6/nylon 6) and polyamide 12 (PA 12/nylon 12). Other polyamides may be suitable for use in the build material composition if the mechanical properties of the polyamide can be altered by the plasticizer disclosed herein.

The polyamide may have a wide processing window of greater than 5° C., which can be defined by the temperature range between the melting point and the re-crystallization temperature. As examples, the polyamide may have a melting point ranging from about 225° C. to about 250° C., from about 155° C. to about 215° C., about 160° C. to about 200° C., from about 170° C. to about 190° C., or from about 182° C. to about 189° C. As another example, the polyamide may have a melting point of about 180° C.

In some examples, the polyamide may be in the form of a powder. In other examples, the polyamide may be in the form of a powder-like material, which includes, for example, short fibers having a length that is greater than its width. In some examples, the powder or powder-like material may be formed from, or may include, short fibers that may, for example, have been cut into short lengths from long strands or threads of material.

The polyamide may be made up of similarly sized particles and/or differently sized particles. In an example, the average particle size of the polyamide ranges from about 2 μm to about 200 μm. In another example, the average particle size of the polyamide ranges from about 10 μm to about 110 μm. In still another example, the average particle size of the polyamide ranges from about 20 μm to about 100 μm. The term “average particle size”, as used herein, may refer to a number-weighted mean diameter or a volume-weighted mean diameter of a particle distribution.

As mentioned above, the plasticizer has the formula (I):

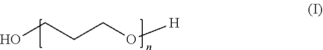

wherein n is an integer ranging from 3 to 8; or the formula (II):

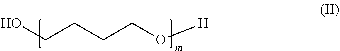

wherein m is an integer ranging from 3 to 8.

In some examples of the build material composition, the plasticizer has the formula (I). The plasticizer of formula (I) may be characterized as an oligomer of 1,3-propanediol or an oligomer of trimethylene glycol. In one specific example, the plasticizer has the formula (I) and wherein n is 4 or 5. Examples of the plasticizer having formula (I) include those in the SENSATIS® and VELVETOL® series from Allessa. As particular examples, SENSATIS® H250 is an example of the plasticizer having formula (I), where n is 4 or 5, and VELVETOL® H500 is an example of the plasticizer having formula (I), where n is 8.

In other examples, the plasticizer has the formula (II). The plasticizer of formula (II) may be characterized as an oligomer of 1,4-butanediol, or an oligomer of tetramethylene glycol, or an oligomer of tetrahydrofuran. In yet other examples, the plasticizer has the formula (II) and wherein m is 5. Commercially available examples of the plasticizer having formula (II) include those in the POLYTHF® series from BASF Corp. and those in the POLYMEG® series from LyondellBasell.

In some examples, the plasticizer has a molecular weight ranging from about 192 Daltons (Da) to about 595 Da. In one example, the plasticizer has a molecular weight of about 250 Da. In another example, the plasticizer has a molecular weight of about 380 Da.

In some examples, the plasticizer may be in the form of a liquid that is absorbed into the polyamide. The plasticizer may have a viscosity at 25° C. ranging from about 100 mPa·s to about 150 mPa·s. In an example, the plasticizer may have a viscosity at 25° C. of about 120 mPa·s.

In some examples, the plasticizer may be made from renewably sourced feedstocks.

In some examples of the build material composition, the plasticizer is present in the build material composition in an amount ranging from about 5 wt % to about 20 wt %, based on the total weight of the build material composition. In an example, the plasticizer is present in the build material composition in an amount ranging from about 5 wt % to about 15 wt %, based on the total weight of the build material composition. In another example, the plasticizer is present in the build material composition in an amount ranging from about 5 wt % to about 10 wt %, based on the total weight of the build material composition. In still another example, the plasticizer is present in the build material composition in an amount of about 8 wt %, based on the total weight of the build material composition.

In some examples, the polyamide and the plasticizer do not substantially absorb radiation having a wavelength within the range of 400 nm to 1400 nm. In other examples, the polyamide and the plasticizer do not substantially absorb radiation having a wavelength within the range of 800 nm to 1400 nm. In still other examples, the polyamide and the plasticizer do not substantially absorb radiation having a wavelength within the range of 400 nm to 1200 nm. In these examples, the polyamide and the plasticizer may be considered to reflect the wavelengths at which the polyamide and the plasticizer do not substantially absorb radiation. The phrase “does not substantially absorb” means that the absorptivity of the polyamide and the plasticizer at a particular wavelength is 25% or less (e.g., 20%, 10%, 5%, etc.).

In some examples, the build material composition consists of the polyamide and the plasticizer with no other components. In other examples, the build material composition may include additional components. Examples of suitable additives include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polyamide and/or may prevent or slow discoloration (e.g., yellowing) of the polyamide by preventing or slowing oxidation of the polyamide. In some examples, the antioxidant may discolor upon reacting with oxygen, and this discoloration may contribute to the discoloration of the build material composition. The antioxidant may be selected to minimize this discoloration. In some examples, the antioxidant may be a radical scavenger. In these examples, the antioxidant may include IRGANOX® 1098 (benzenepropanamide, N,N-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polyamide. In an example, the antioxidant may be included in the build material composition in an amount ranging from about 0.01 wt % to about 5 wt %, based on the total weight of the build material composition 24. In other examples, the antioxidant may be included in the build material composition 24 in an amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any example of the whitener may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

In some examples, the build material composition disclosed herein may be reused/recycled. After a print cycle, some of the build material composition disclosed herein remains non-coalesced/non-fused, and can be reclaimed and used again. This reclaimed build material is referred to as the recycled build material composition. The recycled build material composition may be exposed to 2, 4, 6, 8, 10, or more build cycles (i.e., heating to a temperature ranging from about 50° C. to about 205° C. and then cooling), and reclaimed after each cycle. Between cycles, the recycled build material composition may be mixed with at least some fresh (i.e., not previously used in a 3D printing process) build material composition. In some examples, the weight ratio of the recycled build material composition to the fresh build material composition may be 90:10, 80:20, 70:30, 60:40, 50:50, or 40:60. The weight ratio of the recycled build material composition to the fresh build material composition may depend, in part, on the stability of the build material composition, the discoloration of the recycled build material composition (as compared to the build material composition), the desired aesthetics for the 3D object being formed, the thermal decomposition of the recycled build material composition (as compared to the build material composition), and/or the desired mechanical properties of the 3D object being formed.

In some examples, the build material composition may be formed by blending the polyamide with the plasticizer. As such, an example of a method for making the build material composition comprises blending the polyamide with the plasticizer. In some examples, the liquid plasticizer may be added to the dry polyamide powder and the blended. The plasticizer may be absorbed into the polyamide during the blending.

In some examples, the amounts of the polyamide and the plasticizer that are blended together are selected so that the build material composition formed includes from about 5 wt % to about 20 wt %, from about 5 wt % to about 15 wt %, from about 5 wt % to about 10 wt %, or about 8 wt % of the plasticizer, based on the total weight of the build material composition.

The blending may be accomplished by any suitable means. For example, the polyamide may be blended with the plasticizer using a mixer (e.g., an industrial paddle mixer, an industrial high shear mixer, a resonant acoustic mixer, a ball mill, a powder mill, a jet mill, etc.). In some examples (e.g., when a jet mill is used), the mixer may be used for the blending and may also be used to reduce the particle size of the polyamide. In these examples, the polyamide may have a larger particle size at the beginning of the blending process and may have a particle size within the desired range for the polyamide at the end of the blending process.

In some examples, the blending may be accomplished at a speed ranging from about 800 rotations per minute (rpm) to about 1200 rpm for time period ranging from about 30 seconds to about 180 seconds. In one example, blending may be accomplished at a speed of about 800 rpm for about 30 seconds, then at a speed of about 1200 rpm for about 60 seconds, and then a speed of about 800 rpm for about 30 seconds. In another example, blending may be accomplished at a speed of about 100 gravitations (g, i.e., 981 m/s²) for about 120 seconds.

The blending may be performed before the build material composition is incorporated into a printer. As an example, blending may be performed in a separate powder management station. As another example, blending may be performed as part of the manufacturing of the bulk build material.

3D Printing Kits and Compositions

Any example of the build material composition described herein (e.g., including at least the polyamide and the plasticizer) may be part of a 3D printing kit and/or a 3D printing composition.

In an example, the three-dimensional (3D) printing kit or composition, comprises: a build material composition, including: a polyamide; and a plasticizer having: a formula (I):

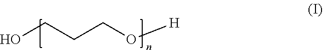

wherein n is an integer ranging from 3 to 8; or a formula (II):

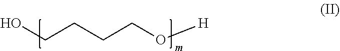

wherein m is an integer ranging from 3 to 8; and a fusing agent to be applied to the at least the portion of the build material composition during 3D printing, the fusing agent including an energy absorber.

In some examples, the 3D printing kit or composition consists of the build material composition and the fusing agent with no other components. In other examples, the 3D printing kit or composition includes additional components, such as another fusing agent, a coloring agent, a detailing agent, or a combination thereof. In still other examples, the 3D printing kit or composition consists of the build material composition, the fusing agent, and the other fusing agent with no other components. In yet other examples, the 3D printing kit or composition consists of the build material composition, the fusing agent(s), and the coloring agent(s) with no other components. In yet other examples, the 3D printing kit or composition consists of the build material composition, the fusing agent(s), and the detailing agent with no other components. In still other examples, the 3D printing kit or composition consists of the build material composition, the fusing agent(s), the coloring agent(s), and the detailing agent with no other components.

In another example, the 3D printing kit or composition includes the build material composition; and a coloring agent, a detailing agent, or both the coloring agent and the detailing agent.

In still some other examples, the 3D printing kit or composition consists of the build material composition and the coloring agent(s) with no other components. In other examples, the 3D printing kit or composition consists of the build material composition and the detailing agent with no other components. In still other examples, the 3D printing kit or composition consists of the build material composition, the coloring agent(s), and the detailing agent with no other components. These example 3D printing kits or compositions may be particularly useful in selective laser sintering (SLS) or selective laser melting (SLM), because these techniques do not utilize a fusing agent.

As used herein, “material set” or “kit” may, in some instances, be synonymous with “composition.” Further, “material set” and “kit” are understood to be compositions comprising one or more components where the different components in the compositions are each contained in one or more containers, separately or in any combination, prior to and during printing but these components can be combined together during printing. The containers can be any type of a vessel, box, or receptacle made of any material. As such, in any of the examples disclosed herein, the components of the 3D printing kit or composition may be maintained separately until used together in examples of the 3D printing method disclosed herein.

Example compositions of the fusing agent, the coloring agent, and the detailing agent that are suitable for use in examples of the multi-fluid kit and/or the 3D printing kit or composition are described below.

Fusing Agents

In the examples of the 3D printing kit, the 3D printing composition, the 3D printing methods, and the 3D printing system disclosed herein, a fusing agent may be used.

In some examples of the 3D printing kit or composition, the fusing agent is a core fusing agent including an energy absorber having absorption at least at wavelengths ranging from 400 nm to 780 nm. In some of these examples of the 3D printing kit or composition, the 3D printing kit or composition further comprises a primer fusing agent including an energy absorber having absorption at wavelengths ranging from 800 nm to 4000 nm and has transparency at wavelengths ranging from 400 nm to 780 nm. As described herein, the energy absorber in the core fusing agent may also absorb energy in the infrared region (e.g., 800 nm to 4000 nm). In one example, the fusing agent is the core fusing agent and the energy absorber is carbon black.

In other examples of the 3D printing kit or composition, the fusing agent is a primer fusing agent including an energy absorber having absorption at wavelengths ranging from 800 nm to 4000 nm and has transparency at wavelengths ranging from 400 nm to 780 nm. In one example, the fusing agent is the primer fusing agent and the energy absorber is an inorganic pigment selected from the group consisting of lanthanum hexaboride, tungsten bronzes, indium tin oxide, aluminum zinc oxide, ruthenium oxide, silver, gold, platinum, iron pyroxenes, modified iron phosphates (AₓFe_{y}PO₄), modified copper pyrophosphates (AₓCu_{y}P₂O₇), and combinations thereof.

As used herein “absorption” means that at least 80% of radiation having wavelengths within the specified range is absorbed. Also as used herein, “transparency” means that 25% or less of radiation having wavelengths within the specified range is absorbed.

Core Fusing Agents

Some examples of the core fusing agent are dispersions including an energy absorber. In some examples, the energy absorber may be an infrared light absorbing colorant. In an example, the energy absorber is a near-infrared light absorber. Any near-infrared colorants, e.g., those produced by Fabricolor, Eastman Kodak, or BASF, Yamamoto, may be used in the core fusing agent. As one example, the core fusing agent may be a printing liquid formulation including carbon black as the energy absorber. Examples of this printing liquid formulation are commercially known as CM997A, 516458, C18928, C93848, C93808, or the like, all of which are available from HP Inc.

As another example, the core fusing agent may be a printing liquid formulation including near-infrared absorbing dyes as the energy absorber. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

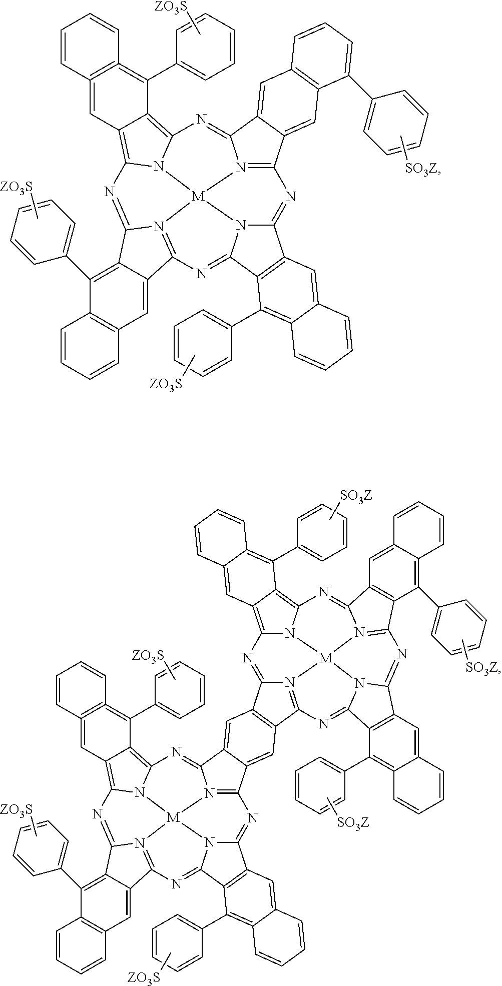

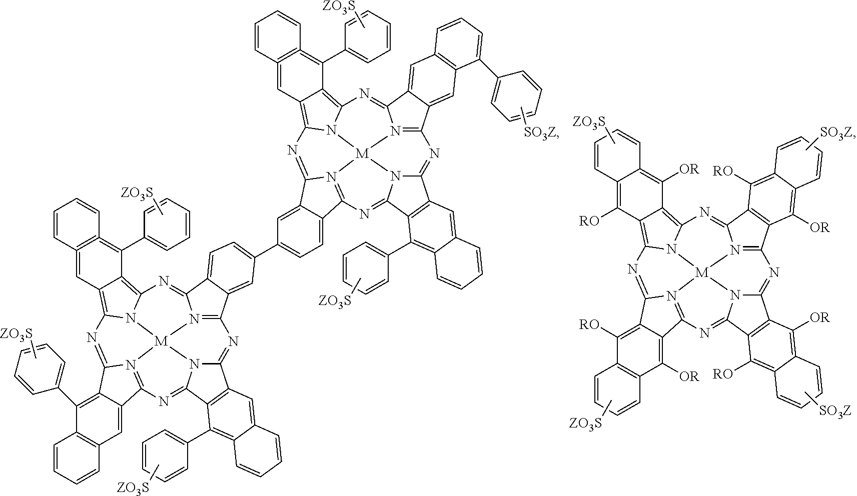

and mixtures thereof. In the above structures, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

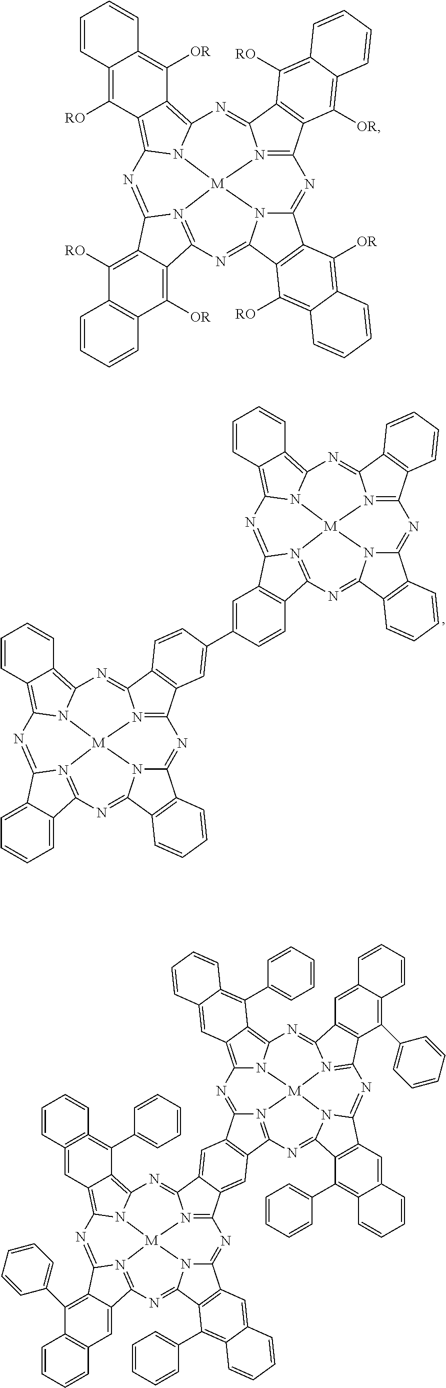

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used. Some examples include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthroquinone dyes or pigments and metal (e.g., nickel) dithiolene dyes or pigments may have the following structures, respectively:

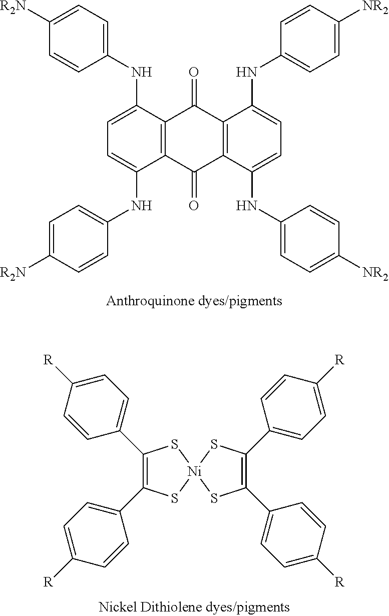

where R in the anthroquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

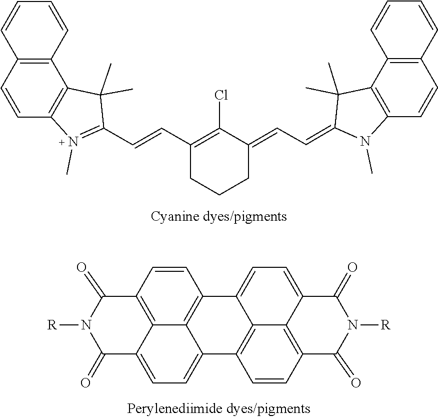

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

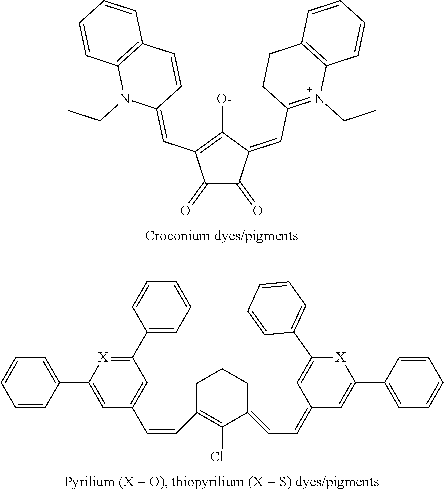

Boron-dipyrromethene dyes or pigments and aza-boron-dipyrromethene dyes or pigments may have the following structures, respectively:

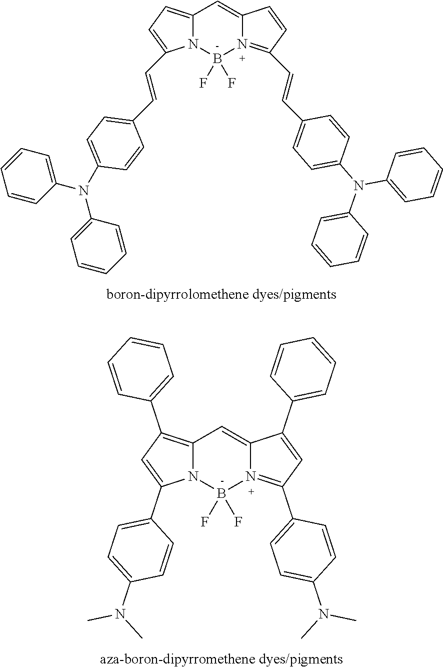

The amount of the energy absorber that is present in the core fusing agent ranges from greater than 0 wt % active to about 40 wt % active based on the total weight of the core fusing agent. In other examples, the amount of the energy absorber in the core fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the core fusing agent having jetting reliability and heat and/or radiation absorbance efficiency.

Primer Fusing Agents

Some examples of the primer fusing agent are dispersions including the energy absorber that has absorption at wavelengths ranging from 800 nm to 4000 nm and transparency at wavelengths ranging from 400 nm to 780 nm. The absorption of this energy absorber is the result of plasmonic resonance effects. Electrons associated with the atoms of the energy absorber may be collectively excited by radiation, which results in collective oscillation of the electrons. The wavelengths that can excite and oscillate these electrons collectively are dependent on the number of electrons present in the energy absorber particles, which in turn is dependent on the size of the energy absorber particles. The amount of energy that can collectively oscillate the particle's electrons is low enough that very small particles (e.g., 1-100 nm) may absorb radiation with wavelengths several times (e.g., from 8 to 800 or more times) the size of the particles. The use of these particles allows the primer fusing agent to be inkjet jettable as well as electromagnetically selective (e.g., having absorption at wavelengths ranging from 800 nm to 4000 nm and transparency at wavelengths ranging from 400 nm to 780 nm).

In an example, this energy absorber has an average particle diameter (e.g., volume-weighted mean diameter) ranging from greater than 0 nm to less than 220 nm. In another example, the energy absorber has an average particle diameter ranging from greater than 0 nm to 120 nm. In a still another example, the energy absorber has an average particle diameter ranging from about 10 nm to about 200 nm.

In an example, the energy absorber of the primer fusing agent is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the energy absorber that is present in the primer fusing agent ranges from greater than 0 wt % active to about 40 wt % active based on the total weight of the primer fusing agent. In other examples, the amount of the energy absorber in the primer fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the primer fusing agent having jetting reliability and heat and/or radiation absorbance efficiency.

The energy absorber of the primer fusing agent may, in some instances, be dispersed with a dispersant. As such, the dispersant helps to uniformly distribute the energy absorber throughout the primer fusing agent. Examples of suitable dispersants include polymer or small molecule dispersants, charged groups attached to the energy absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the primer fusing agent may range from about 10 wt % to about 200 wt % based on the weight of the energy absorber in the primer fusing agent.

A silane coupling agent may also be added to the primer fusing agent to help bond the organic and inorganic materials. Examples of suitable silane coupling agents include the SILQUEST® A series manufactured by Momentive.

Whether a single silane coupling agent is used or a combination of silane coupling agents is used, the total amount of silane coupling agent(s) in the primer fusing agent may range from about 0.1 wt % active to about 50 wt % active based on the weight of the energy absorber in the primer fusing agent. In an example, the total amount of silane coupling agent(s) in the primer fusing agent ranges from about 1 wt % active to about 30 wt % active based on the weight of the energy absorber. In another example, the total amount of silane coupling agent(s) in the primer fusing agent ranges from about 2.5 wt % active to about 25 wt % active based on the weight of the energy absorber.

Fusing Agent Vehicles

As used herein, “FA vehicle” may refer to the liquid in which the energy absorber is dispersed or dissolved to form the fusing agent (e.g., the core fusing agent or the primer fusing agent). A wide variety of FA vehicles, including aqueous and non-aqueous vehicles, may be used in the fusing agent. In some examples, the FA vehicle may include water alone or a non-aqueous solvent alone with no other components. In other examples, the FA vehicle may include other components, depending, in part, upon the applicator that is to be used to dispense the fusing agent. Examples of other suitable fusing agent components include co-solvent(s), humectant(s), surfactant(s), antimicrobial agent(s), anti-kogation agent(s), and/or chelating agent(s).

The solvent of the fusing agent may be water or a non-aqueous solvent (e.g., ethanol, acetone, n-methyl pyrrolidone, aliphatic hydrocarbons, etc.). In some examples, the fusing agent consists of the energy absorber and the solvent (without other components). In these examples, the solvent makes up the balance of the fusing agent.

Classes of organic co-solvents that may be used in a water-based fusing agent include aliphatic alcohols, aromatic alcohols, diols, glycol ethers, polyglycol ethers, lactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, 2-pyrrolidone, 1-methyl-2-pyrrolidone, N-(2-hydroxyethyl)-2-pyrrolidone, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

Some examples of suitable co-solvents include water-soluble high-boiling point solvents, which have a boiling point of at least 120° C., or higher. Some examples of high-boiling point solvents include 2-pyrrolidone (i.e., 2-pyrrolidinone, boiling point of about 245° C.), 1-methyl-2-pyrrolidone (boiling point of about 203° C.), N-(2-hydroxyethyl)-2-pyrrolidone (boiling point of about 140° C.), 2-methyl-1,3-propanediol (boiling point of about 212° C.), and combinations thereof.

The co-solvent(s) may be present in the fusing agent in a total amount ranging from about 1 wt % to about 50 wt % based upon the total weight of the fusing agent, depending upon the jetting architecture of the applicator. In an example, the total amount of the co-solvent(s) present in the fusing agent is 25 wt % based on the total weight of the fusing agent.

The co-solvent(s) of the fusing agent may depend, in part, upon the jetting technology that is to be used to dispense the fusing agent. For example, if thermal inkjet printheads are to be used, water and/or ethanol and/or other longer chain alcohols (e.g., pentanol) may be the solvent (i.e., makes up 35 wt % or more of the fusing agent) or co-solvents. For another example, if piezoelectric inkjet printheads are to be used, water may make up from about 25 wt % to about 30 wt % of the fusing agent, and the solvent (i.e., 35 wt % or more of the fusing agent) may be ethanol, isopropanol, acetone, etc. The co-solvent(s) of the fusing agent may also depend, in part, upon the build material composition that is being used with the fusing agent. For a hydrophobic powder (such as the polyamides disclosed herein), the FA vehicle may include a higher solvent content in order to improve the flow of the fusing agent into the build material composition.

The FA vehicle may also include humectant(s). In an example, the total amount of the humectant(s) present in the fusing agent ranges from about 3 wt % active to about 10 wt % active, based on the total weight of the fusing agent. An example of a suitable humectant is ethoxylated glycerin having the following formula:

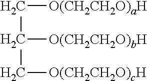

in which the total of a+b+c ranges from about 5 to about 60, or in other examples, from about 20 to about 30. An example of the ethoxylated glycerin is LIPON IC® EG-1 (LEG-1, glycereth-26, a+b+c=26, available from Lipo Chemicals).

In some examples, the FA vehicle includes surfactant(s) to improve the jettability of the fusing agent. Examples of suitable surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), and combinations thereof. In other examples, the surfactant is an ethoxylated low-foam wetting agent (e.g., SURFYNOL® 440 or SURFYNOL® CT-111 from Evonik Degussa) or an ethoxylated wetting agent and molecular defoamer (e.g., SURFYNOL® 420 from Evonik Degussa). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (polyether siloxane) available from Evonik Degussa). Yet another suitable surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used or a combination of surfactants is used, the total amount of surfactant(s) in the fusing agent may range from about 0.01 wt % active to about 10 wt % active based on the total weight of the fusing agent. In an example, the total amount of surfactant(s) in the fusing agent may be about 3 wt % active based on the total weight of the fusing agent.

An anti-kogation agent may be included in the fusing agent that is to be jetted using thermal inkjet printing. Kogation refers to the deposit of dried printing liquid (e.g., fusing agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS® 03A or CRODAFOS® N-3 acid from Croda), dextran 500 k, CRODAFOS™ HCE (phosphate-ester from Croda Int.), CRODAFOS® N10 (oleth-10-phosphate from Croda Int.), DISPERSOGEN® LFH (polymeric dispersing agent with aromatic anchoring groups, acid form, anionic, from Clariant), or a combination of oleth-3-phosphate and a low molecular weight (e.g., <5,000) acrylic acid polymer (e.g., commercially available as CARBOSPERSE™ K-7028 Polyacrylate from Lubrizol).

Whether a single anti-kogation agent is used or a combination of anti-kogation agents is used, the total amount of anti-kogation agent(s) in the fusing agent may range from greater than 0.10 wt % active to about 1.5 wt % active based on the total weight of the fusing agent. In an example, the oleth-3-phosphate is included in an amount ranging from about 0.20 wt % active to about 0.60 wt % active, and the low molecular weight polyacrylic acid polymer is included in an amount ranging from about 0.005 wt % active to about 0.03 wt % active.

The FA vehicle may also include antimicrobial agent(s). Suitable antimicrobial agents include biocides and fungicides. Example antimicrobial agents may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.).

In an example, the fusing agent may include a total amount of antimicrobial agents that ranges from about 0.0001 wt % active to about 1 wt % active. In an example, the antimicrobial agent(s) is/are a biocide(s) and is/are present in the fusing agent in an amount of about 0.25 wt % active (based on the total weight of the fusing agent).

Chelating agents (or sequestering agents) may be included in the FA vehicle to eliminate the deleterious effects of heavy metal impurities. Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

Whether a single chelating agent is used or a combination of chelating agents is used, the total amount of chelating agent(s) in the fusing agent may range from greater than 0 wt % active to about 2 wt % active based on the total weight of the fusing agent. In an example, the chelating agent(s) is/are present in the fusing agent in an amount of about 0.04 wt % active (based on the total weight of the fusing agent).

Coloring Agents

In the examples of the 3D printing kit, the 3D printing composition, the 3D printing methods, and the 3D printing system disclosed herein, a coloring agent may be used. As such, some examples of the 3D printing kit or composition further comprise a coloring agent selected from the group consisting of a black agent, a cyan agent, a magenta agent, and a yellow agent.

The coloring agent may include a colorant, a co-solvent, and a balance of water. In some examples, the coloring agent consists of these components, and no other components. In some other examples, the coloring agent may further include a binder (e.g., an acrylic latex binder, which may be a copolymer of any two or more of styrene, acrylic acid, methacrylic acid, methyl methacrylate, ethyl methacrylate, and butyl methacrylate) and/or a buffer. In still other examples, the coloring agent may further include additional components, such as dispersant(s), humectant(s), surfactant(s), anti-kogation agent(s), antimicrobial agent(s), and/or chelating agent(s) (each of which is described above in reference to the fusing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color.

In some instances, the colorant of the coloring agent may be transparent to infrared wavelengths. In other instances, the colorant of the coloring agent may not be completely transparent to infrared wavelengths, but does not absorb enough radiation to sufficiently heat the build material composition in contact therewith. In an example, the colorant absorbs less than 10% of radiation having wavelengths in a range of 650 nm to 2500 nm. In another example, the colorant absorbs less than 20% of radiation having wavelengths in a range of 650 nm to 4000 nm.

The colorant of the coloring agent is also capable of absorbing radiation with wavelengths of 650 nm or less. As such, the colorant absorbs at least some wavelengths within the visible spectrum, but absorbs little or no wavelengths within the near-infrared spectrum. This is in contrast to at least some examples of the energy absorber in the fusing agent, which absorbs wavelengths within the near-infrared spectrum and/or the infrared spectrum (e.g., the fusing agent absorbs 80% or more of radiation with wavelengths within the near-infrared spectrum and/or the infrared spectrum). As such, the colorant in the coloring agent will not substantially absorb the fusing radiation, and thus will not initiate coalescing/fusing of the build material composition in contact therewith when the build material composition is exposed to the fusing radiation.

Examples of IR transparent colorants include acid yellow 23 (AY 23), AY17, acid red 52 (AR 52), AR 289, and reactive red 180 (RR 180). Examples of colorants that absorb some visible wavelengths and some IR wavelengths include cyan colorants, such as direct blue 199 (DB 199) and pigment blue 15:3 (PB 15:3).

In other examples, the colorant may be any azo dye having sodium or potassium counter ion(s) or any diazo (i.e., double azo) dye having sodium or potassium counter ion(s).

Examples of black dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

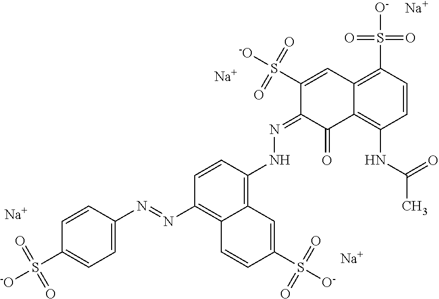

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

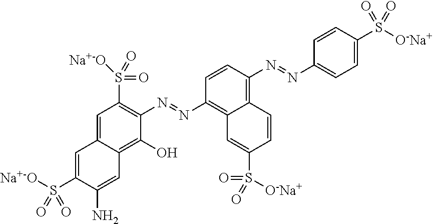

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

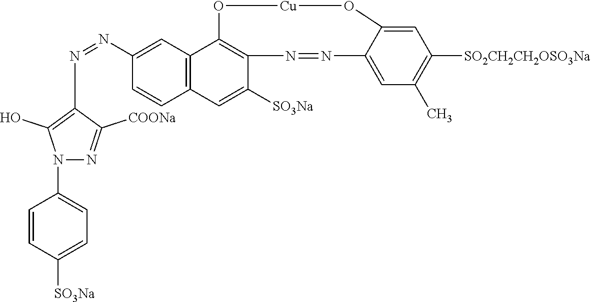

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

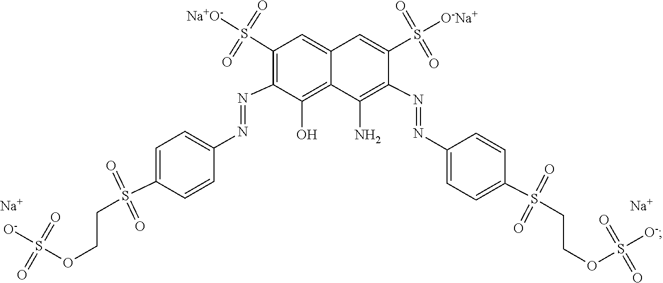

and combinations thereof. Some other commercially available examples of black dyes include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

Examples of cyan dyes include ethyl-[4-[[4-[ethyl-[(3-sulfophenyl) methyl]amino]phenyl]-(2-sulfophenyl) ethylidene]-1-cyclohexa-2,5-dienylidene]-[(3-sulfophenyl) methyl]azanium with a chemical structure of:

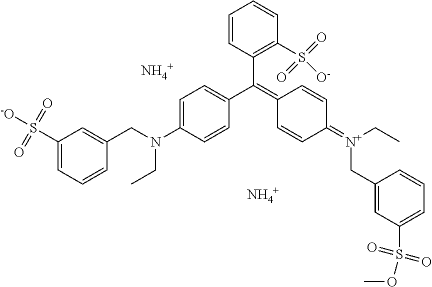

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

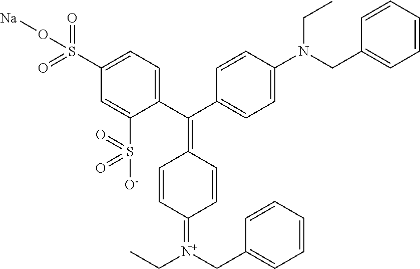

(commercially available as Acid Blue 7); and a phthalocyanine with a chemical structure of:

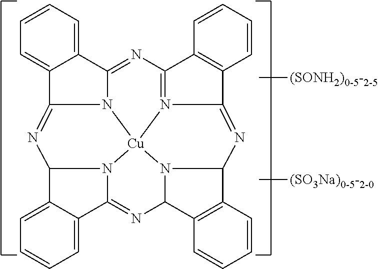

(commercially available as Direct Blue 199); and combinations thereof.

An example of the pigment based coloring agent may include from about 1 wt % active to about 10 wt % active of pigment(s), from about 10 wt % to about 30 wt % of co-solvent(s), from about 1 wt % to about 10 wt % of dispersant(s), from about 0.1 wt % active to about 5 wt % active of binder(s), from 0.01 wt % active to about 1 wt % active of anti-kogation agent(s), from about 0.05 wt % active to about 0.1 wt % active antimicrobial agent(s), and a balance of water. An example of the dye based coloring agent may include from about 1 wt % active to about 7 wt % active of dye(s), from about 10 wt % to about 30 wt % of co-solvent(s), from about 1 wt % to about 7 wt % of dispersant(s), from about 0.05 wt % active to about 0.1 wt % active antimicrobial agent(s), from 0.05 wt % active to about 0.1 wt % active of chelating agent(s), from about 0.005 wt % active to about 0.2 wt % active of buffer(s), and a balance of water.

Some examples of the coloring agent include a set of cyan, magenta, and yellow agents, such as C1893A (cyan), C1984A (magenta), and C1985A (yellow); or C4801A (cyan), C4802A (magenta), and C4803A (yellow); all of which are available from HP Inc. Other commercially available coloring agents include C9384A (printhead HP 72), C9383A (printhead HP 72), C4901A (printhead HP 940), and C4900A (printhead HP 940).

Detailing Agents

In the examples of the 3D printing kit, the 3D printing composition, the 3D printing methods, and the 3D printing system disclosed herein a detailing agent may be used. As such, some examples of the 3D printing kit or composition further comprise a detailing agent including a surfactant, a co-solvent, and water.

The detailing agent may include a surfactant, a co-solvent, and a balance of water. In some examples, the detailing agent consists of these components, and no other components. In some other examples, the detailing agent may further include additional components, such as humectant(s), anti-kogation agent(s), antimicrobial agent(s), and/or chelating agent(s) (each of which is described above in reference to the fusing agent).

The surfactant(s) that may be used in the detailing agent include any of the surfactants listed above in reference to the fusing agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the fusing agent. The total amount of co-solvent(s) in the detailing agent may range from about 1.00 wt % to about 20.00 wt % with respect to the total weight of the detailing agent. Similar to the fusing agent, the co-solvent(s) of the detailing agent may depend, in part upon the jetting technology that is to be used to dispense the detailing agent. For example, if thermal inkjet printheads are to be used, water and/or ethanol and/or other longer chain alcohols (e.g., pentanol) may make up 35 wt % or more of the detailing agent. For another example, if piezoelectric inkjet printheads are to be used, water may make up from about 25 wt % to about 30 wt % of the detailing agent, and 35 wt % or more of the detailing agent may be ethanol, isopropanol, acetone, etc.

The balance of the detailing agent is water. As such, the amount of water may vary depending upon the amounts of the other components that are included.

While the example detailing agent described herein does not include a colorant, it is to be understood that any of the colorants described for the coloring agent (i.e., transparent to infrared wavelengths) may be used in the detailing agent. As one example, it may be desirable to add color to the detailing agent when the detailing agent is applied to the edge of a colored part. Color in the detailing agent may be desirable when used at a part edge because some of the colorant may become embedded in the build material that fuses/coalesces at the edge.

Printing Methods and Methods of Use

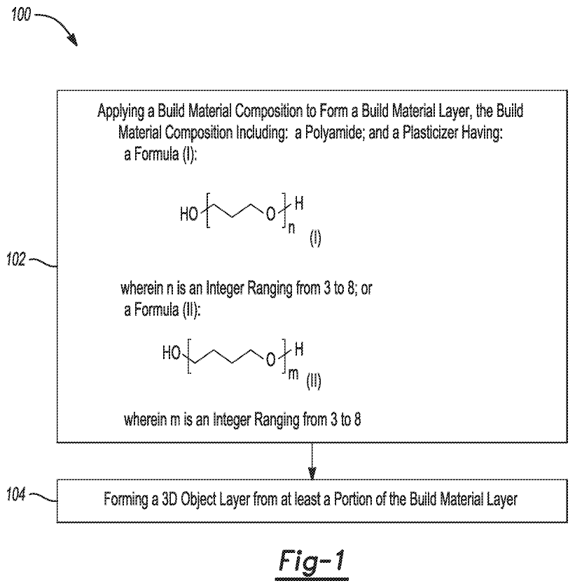

Referring now to FIG. 1, an example a method 100 for 3D printing is depicted. The examples of the method 100 may use examples of the 3D printing kit and/or composition disclosed herein. Additionally, the examples of the method 100 may be used to print 3D objects that exhibit ductility (due to the plasticizer in the build material composition).

As shown in FIG. 1, the method 100 for three-dimensional (3D) printing comprises: applying a build material composition to form a build material layer, the build material composition including: a polyamide; and a plasticizer having: a formula (I):

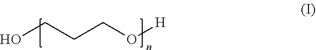

wherein n is an integer ranging from 3 to 8; or a formula (II):

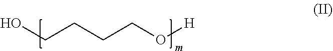

wherein m is an integer ranging from 3 to 8 (reference numeral 102); and forming a 3D object layer from at least a portion of the build material layer (reference numeral 104).

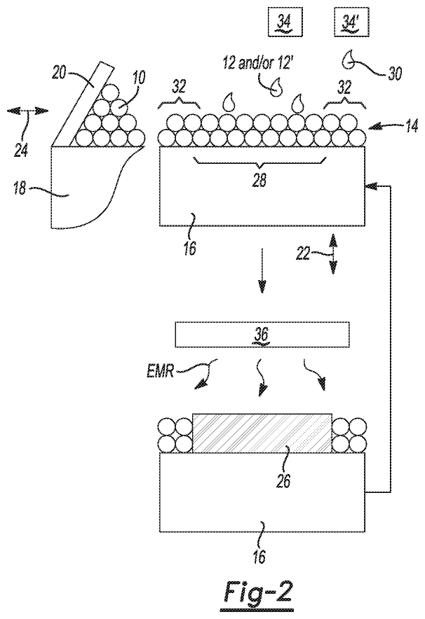

In some examples of the method 100, forming the 3D object layer includes: selectively applying a fusing agent on the at least the portion of the build material layer; and exposing the build material layer to electromagnetic radiation to coalesce the polyamide in the at least the portion. This example of the method will be further described in reference to FIG. 2.

In other examples of the method 100, forming the 3D object layer includes selectively exposing the at least the portion of the build material layer to a laser. This example of the method 100 will also be described below.

While not shown, any example of the method 100 may include forming the build material composition. In an example, the build material composition is formed prior to applying the build material composition to form the build material layer. The build material composition may be formed by blending the polyamide with the plasticizer (as described above).

Furthermore, prior to execution of any examples of the method 100, it is to be understood that a controller may access data stored in a data store pertaining to a 3D part/object that is to be printed. For example, the controller may determine the number of layers of the build material composition that are to be formed, the locations at which any of the agents is/are to be deposited on each of the respective layers, etc.

Printing with Fusing Agents

Referring now to FIG. 2, an example of the method 100, which utilizes the build material composition 10 (including at least the polyamide and the plasticizer) and the fusing agent 12 or 12′, is graphically depicted.

In FIG. 2, a layer 14 of the build material composition 10 is applied on a build area platform 16. A printing system may be used to apply the build material composition 10. The printing system may include the build area platform 16, a build material supply 18 containing the build material composition 10, and a build material distributor 20.

The build area platform 16 receives the build material composition 10 from the build material supply 18. The build area platform 16 may be moved in the directions as denoted by the arrow 22, e.g., along the z-axis, so that the build material composition 10 may be delivered to the build area platform 16 or to a previously formed layer. In an example, when the build material composition 10 is to be delivered, the build area platform 16 may be programmed to advance (e.g., downward) enough so that the build material distributor 20 can push the build material composition 10 onto the build area platform 16 to form a substantially uniform layer of the build material composition 10 thereon. The build area platform 16 may also be returned to its original position, for example, when a new part is to be built.

The build material supply 18 may be a container, bed, or other surface that is to position the build material composition 10 between the build material distributor 20 and the build area platform 16. The build material supply 18 may include heaters so that the build material composition 10 is heated to a supply temperature ranging from about 25° C. to about 150° C. In these examples, the supply temperature may depend, in part, on the build material composition 10 used and/or the 3D printer used. As such, the range provided is one example, and higher or lower temperatures may be used.

The build material distributor 20 may be moved in the directions as denoted by the arrow 24, e.g., along the y-axis, over the build material supply 18 and across the build area platform 16 to spread the layer 14 of the build material composition 10 over the build area platform 16. The build material distributor 20 may also be returned to a position adjacent to the build material supply 18 following the spreading of the build material composition 10. The build material distributor 20 may be a blade (e.g., a doctor blade), a roller, a combination of a roller and a blade, and/or any other device capable of spreading the build material composition 10 over the build area platform 16. For instance, the build material distributor 20 may be a counter-rotating roller. In some examples, the build material supply 18 or a portion of the build material supply 18 may translate along with the build material distributor 20 such that build material composition 10 is delivered continuously to the build material distributor 20 rather than being supplied from a single location at the side of the printing system as depicted in FIG. 2.

The build material supply 18 may supply the build material composition 10 into a position so that it is ready to be spread onto the build area platform 16. The build material distributor 20 may spread the supplied build material composition 10 onto the build area platform 16. The controller (not shown) may process “control build material supply” data, and in response, control the build material supply 18 to appropriately position the particles of the build material composition 10, and may process “control spreader” data, and in response, control the build material distributor 20 to spread the build material composition 10 over the build area platform 16 to form the layer 14 of the build material composition 10 thereon. In FIG. 2, one build material layer 14 has been formed.

The layer 14 has a substantially uniform thickness across the build area platform 16. In an example, the build material layer 14 has a thickness ranging from about 50 μm to about 120 μm. In another example, the thickness of the build material layer 14 ranges from about 30 μm to about 300 μm. It is to be understood that thinner or thicker layers may also be used. For example, the thickness of the build material layer 14 may range from about 20 μm to about 500 μm. The layer thickness may be about 2× (i.e., 2 times) the average diameter of the build material composition particles at a minimum for finer part definition. In some examples, the layer 14 thickness may be about 1.2× the average diameter of the build material composition particles.

After the build material composition 10 has been applied, and prior to further processing, the build material layer 14 may be exposed to heating. In an example, the heating temperature may be below the melting point of the polyamide of the build material composition 10. As examples, the pre-heating temperature may range from about 5° C. to about 50° C. below the melting point of the polyamide. In an example, the pre-heating temperature ranges from about 50° C. to about 205° C. In still another example, the pre-heating temperature ranges from about 100° C. to about 190° C. The low pre-heating temperature may enable the non-patterned build material composition 10 to be easily removed from the 3D object after completion of the 3D object. In these examples, the pre-heating temperature may depend, in part, on the build material composition 10 used. As such, the ranges provided are some examples, and higher or lower temperatures may be used.

Pre-heating the layer 14 may be accomplished by using any suitable heat source that exposes all of the build material composition 10 in the layer 14 to the heat. Examples of the heat source include a thermal heat source (e.g., a heater (not shown) integrated into the build area platform 16 (which may include sidewalls)) or a radiation source 36.

After the layer 14 is formed, and in some instances is pre-heated, the fusing agent(s) 12 and/or 12′ is/are selectively applied on at least some of the build material composition 10 in the layer 14.

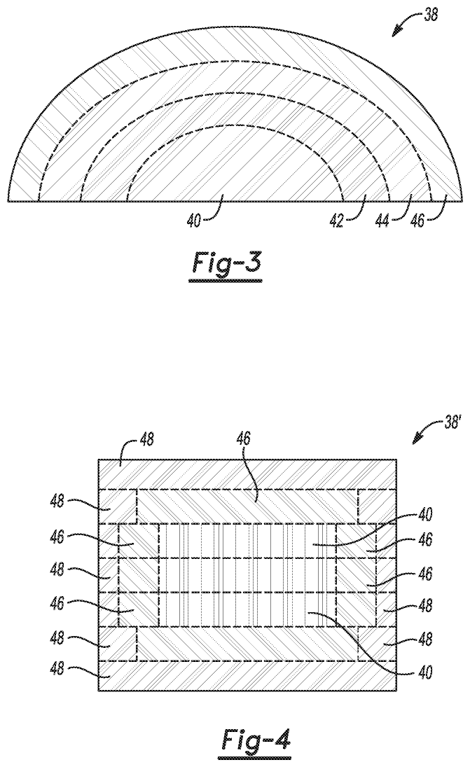

To form a layer 26 of a 3D object, at least a portion (e.g., portion 28) of the layer 14 of the build material composition 10 is patterned with the fusing agent 12, 12′. Either fusing agent 12 or 12′ may be used. When it is desirable to form a white, colored, or slightly tinted object layer 26, the primer fusing agent 12′ may be used to pattern the build material composition 10. The primer fusing agent 12′ is clear or slightly tinted, and thus the resulting 3D object layer 26 may appear white or the color of the build material composition 10. When it is desirable to form a darker color or black object layer 26, the core fusing agent 12 may be used. The core fusing agent 12 is dark or black, and thus the resulting 3D object layer 26 may appear grey, black or another dark color. The two fusing agents 12, 12′ may be used to pattern different portions of a single build material layer 14, which will be described further in reference to FIGS. 3 and 4. Color may also be added by using the coloring agent, which will also be described further in reference to FIGS. 3 and 4.

The volume of the fusing agent 12, 12′ that is applied per unit of the build material composition 10 in the patterned portion 28 may be sufficient to absorb and convert enough electromagnetic radiation so that the build material composition 10 in the patterned portion 28 will coalesce/fuse. The volume of the fusing agent 12, 12′ that is applied per unit of the build material composition 10 may depend, at least in part, on the energy absorber used, the energy absorber loading in the fusing agent 12, 12′, and the build material composition 10 used.

In the example shown in FIG. 2, the detailing agent 30 is also selectively applied to the portion(s) 32 of the layer 14. The portion(s) 32 are not patterned with the fusing agent 12, 12′ and thus are not to become part of the final 3D object layer 26. Thermal energy generated during radiation exposure may propagate into the surrounding portion(s) 32 that do not have the fusing agent 12, 12′ applied thereto. This thermal energy could melt the plasticizer in the portion(s) 32, which is undesirable. The propagation of thermal energy may be inhibited, and thus the melting of the plasticizer and/or the coalescence of the non-patterned build material portion(s) 32 may be prevented, when the detailing agent 30 is applied to these portion(s) 32.

In this example of the method 100, any of the agents 12 and/or 12′ and 30 dispensed from an applicator 34, 34′. The applicator(s) 34, 34′ may each be a thermal inkjet printhead, a piezoelectric printhead, a continuous inkjet printhead, etc., and the selective application of the agent(s) 12 and/or 12′ and 30 may be accomplished by thermal inkjet printing, piezo electric inkjet printing, continuous inkjet printing, etc. The controller may process data, and in response, control the applicator(s) 34, 34′ to deposit the agent(s) 12 and/or 12′ and 30 onto predetermined portion(s) 28, 32 of the build material composition 10. It is to be understood that the applicators 34, 34′ may be separate applicators or a single applicator with several individual cartridges for dispensing the respective agents 12 and/or 12′ and 30.

It is to be understood that the selective application of the agents 12 and/or 12′ and 30 may be accomplished in a single printing pass or in multiple printing passes. In some examples, the agent(s) 12 and/or 12′ and 30 is/are selectively applied in a single printing pass. In some other examples, the agent(s) 12 and/or 12′ and 30 is/are selectively applied in multiple printing passes. In one of these examples, the number of printing passes ranging from 2 to 4. In still other examples, 2 or 4 printing passes are used. It may be desirable to apply the agent(s) 12 and/or 12′ and 30 in multiple printing passes to increase the amount, e.g., of the energy absorber, detailing agent, etc. that is applied to the build material composition 10, to avoid liquid splashing, to avoid displacement of the build material composition 10, etc.

After the agents 12 and/or 12′ and 20 are selectively applied in the specific portion(s) 28, 32 of the layer 14, the entire layer 14 of the build material composition 24 is exposed to electromagnetic radiation (shown as EMR in FIG. 2).

The electromagnetic radiation is emitted from the radiation source 36. The length of time the electromagnetic radiation is applied for, or energy exposure time, may be dependent, for example, on one or more of: characteristics of the radiation source 36; characteristics of the build material composition 10; and/or characteristics of the fusing agent 12, 12′.

It is to be understood that the electromagnetic radiation exposure may be accomplished in a single radiation event or in multiple radiation events. In an example, the exposing of the build material composition 10 is accomplished in multiple radiation events. In a specific example, the number of radiation events ranges from 3 to 8. In still another specific example, the exposure of the build material composition 10 to electromagnetic radiation may be accomplished in 3 radiation events. It may be desirable to expose the build material composition 10 to electromagnetic radiation in multiple radiation events to counteract a cooling effect that may be brought on by the amount of the agents 12 and/or 12′ and 30 that is applied to the build material layer 14. Additionally, it may be desirable to expose the build material composition 10 to electromagnetic radiation in multiple radiation events to sufficiently elevate the temperature of the build material composition 10 in the portion(s) 28, without over heating the build material composition 10 in the non-patterned portion(s) 32.

The fusing agent 12, 12′ enhances the absorption of the radiation, converts the absorbed radiation to thermal energy, and promotes the transfer of the thermal heat to the build material composition 10 in contact therewith. In an example, the fusing agent 12, 12′ sufficiently elevates the temperature of the build material composition 10 in the portion 28 to a temperature above the melting point of the polyamide, allowing coalescing/fusing (e.g., thermal merging, melting, binding, etc.) of the build material composition 10 to take place. The application of the electromagnetic radiation forms the 3D object layer 26.

In some examples, the electromagnetic radiation has a wavelength ranging from 800 nm to 4000 nm, or from 800 nm to 1400 nm, or from 800 nm to 1200 nm. Radiation having wavelengths within the provided ranges may be absorbed (e.g., 80% or more of the applied radiation is absorbed) by the fusing agent 12, 12′ and may heat the build material composition 10 in contact therewith, and may not be substantially absorbed (e.g., 25% or less of the applied radiation is absorbed) by the non-patterned build material composition 10 in portion(s) 32.

The application of the electromagnetic radiation forms the 3D object layer 26. Because the plasticizer is present in the build material composition 10, the entire 3D object layer 26′ that is formed will have increased ductility (e.g., compared to a 3D object layer that is formed without the plasticizer).

After the 3D object layer 26 is formed, additional layer(s) may be formed thereon to create an example of the 3D object. To form the next layer, additional build material composition 10 may be applied on the layer 26. The fusing agent 12, 12′ is then selectively applied on at least a portion of the additional build material composition 10, according to the 3D object model. The detailing agent 30 may be applied in any area of the additional build material composition 10 where coalescence is not desirable. After the agent(s) 12 and/or 12′ and 30 are applied, the entire layer of the additional build material composition 10 is exposed to electromagnetic radiation in the manner described herein. The application of additional build material composition 10, the selective application of the agent(s) 12 and/or 12′ and 30 and the electromagnetic radiation exposure may be repeated a predetermined number of cycles to form the final 3D object in accordance with the 3D object model.

Additional Printing Methods with Multiple Fusing Agents

In some other examples of the method 100, the primer fusing agent 12′ and the core fusing agent 12 may be used together. For example, it may be desirable to utilize the core fusing agent 12 to form the core (e.g., the center or inner-most portion) of the 3D object, and it may be desirable to utilize the primer fusing agent 12′ to form the outermost layers of the 3D object. The core fusing agent 12 can impart strength to the core of the 3D object, while the primer fusing agent 12′ enables white or a color to be exhibited at the exterior of the 3D object.

An example of a 3D object 38 formed with the primer fusing agent 12′ and the core fusing agent 12 is shown in FIG. 3. To form this example of the 3D object 38, the core fusing agent 12 would be applied on multiple layers of the build material composition 10 to pattern the inner portions 40, 42 and 44, and the primer fusing agent 12′ would be applied on multiple layers of the build material composition 10 to pattern the outermost (white) layer 46. After each build material layer is patterned with the agent(s) 12 and/or 12′, electromagnetic radiation may be applied to solidify the respective patterned build material layers.

To impart color to the 3D object 38 shown in FIG. 3, the coloring agent described herein may be applied with the primer fusing agent 12′ and/or on the layer 46 after the 3D object 38 is formed.

Another example of a 3D object 38′ formed with the primer fusing agent 12′ and the core fusing agent 12 is shown in FIG. 4. In this example, the coloring agent is applied with the primer fusing agent 12′ to generate colored portions 48 at the exterior surfaces of the object 38′. Since the primer fusing agent 12′ is clear or slightly tinted and the build material composition 10 is white or off-white, the color of the coloring agent will be the color of the resulting colored portions 48, as the colorant of the coloring agent becomes embedded throughout the coalesced/fused build material composition of the colored portions 48.

To form this example of the 3D object 38′, the outermost build material layer(s) and the outermost edges of the middle build material layers would be patterned with the primer fusing agent 12′ and the coloring agent to form colored portions 48 of the object 38′. The innermost portions of the middle build material layers would be patterned with the core fusing agent 12 to form the core portions 40 of the object 38′. Portions of the build material layers that are between the outermost build material layer(s) and the middle build material layers, and that are between the outermost edges and the innermost portions of the middle build material layers may be patterned with the primer fusing agent 12′ to form white portion(s) 46 of the object 38′. These white portions are formed between the core portions 40 and the colored portions 48. These white portions 46 form a mask over the core portions 40 because they optically isolate the black core portion(s) 40.

While several variations of the objects 38, 38′ have been described, it is to be understood that the fusing agents 12 and/or 12′ may be used to form any desirable 3D object.

Printing Using SLS/SLM

In still another example of the method 100, the layers of the 3D object are formed via selective laser sintering (SLS) or selective laser melting (SLM). In this example of the method 100, no fusing agent 12, 12′ is applied on the build material composition 10. Rather, an energy beam is used to selectively apply radiation to the portions of the build material composition 10 that are to coalesce/fuse to become part of the object.

In this example, the source of electromagnetic radiation may be a laser or other tightly focused energy source that may selectively apply radiation to the build material composition 10. The laser may emit light through optical amplification based on the stimulated emission of radiation. The laser may emit light coherently (i.e., constant phase difference and frequency), which allows the radiation to be emitted in the form of a laser beam that stays narrow over large distances and focuses on a small area. In some example, the laser or other tightly focused energy source may be a pulse laser (i.e., the optical power appears in pluses). Using a pulse laser allows energy to build between pluses, which enable the beam to have more energy. A single laser or multiple lasers may be used.

Also in this example, the coloring agent may be applied wherever is it desirable to impart color to the 3D object that is formed.

To further illustrate the present disclosure, examples are given herein. It is to be understood that these example are provided for illustrative purposes and are not to be construed as limiting the scope of the present disclosure.

### EXAMPLES

### Example 1

Two examples of the build material composition disclosed herein were prepared. Each example build material composition included polyamide 12 (VESTOSINT® Z2723 available from Evonik Degussa). Poly(trimethylene glycol) plasticizers were used in the example build material compositions—one with a molecular weight of 250 Da (SENSATIS® H250) and the other with a molecular weight of 500 Da (VELVETOL® H500).

Each of the plasticizers was blended, at 8% loading, with the polyamide 12 to form the respective example build material compositions. The mixing profile included: 800 rpm for about 30 seconds, 1200 rpm for about 50 seconds, and 800 rpm for about 30 seconds. The first example build material composition was made with the 250 Da plasticizer and the second example build material composition was made with the 500 Da plasticizer.

Four example 3D objects (type 5 dogbones) were made with each of the example build material compositions. Each example 3D object was made via injection molding. For comparison, the polyamide 12 (VESTOSINT® Z2723) without any plasticizer was also injection molded to form four different control sample dogbones.

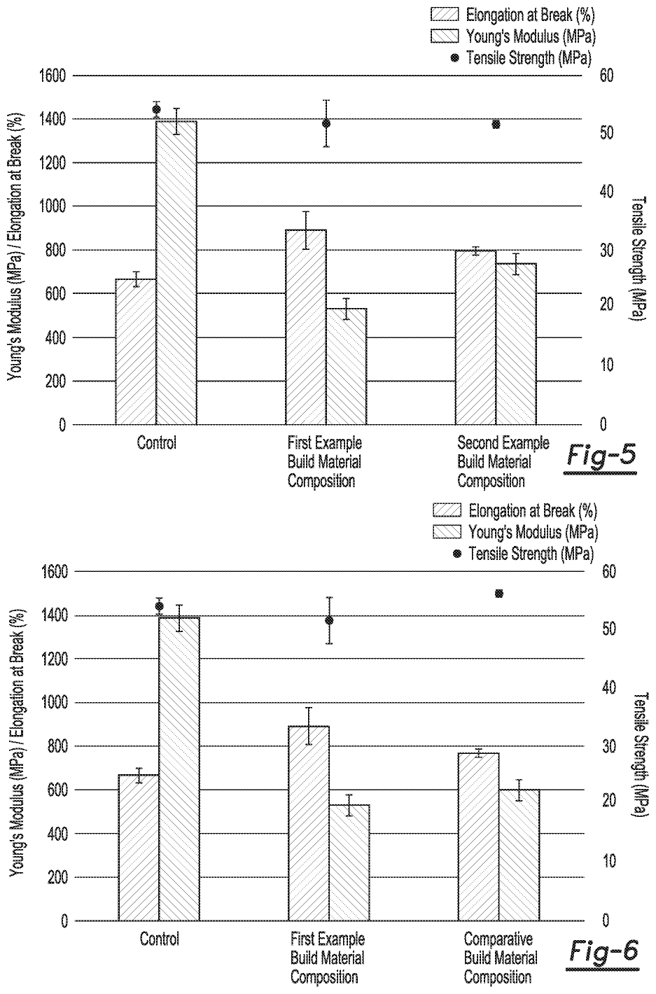

The ultimate tensile strength, elongation at break, and Young's Modulus of the 3D objects and control samples formed were measured using Instron testing equipment. The average results of the four dogbones (3D objects) formed with the first example build material composition, the four dogbones (3D objects) formed with the second example build material composition, and the four control sample dogbones (3Dobjects) are shown in FIG. 5. In FIG. 5, the ultimate tensile strength (in MPa, right Y axis), the elongation at break (in %, left Y axis), and the Young's Modulus (in MPa, left axis) are shown on the y-axes. Each 3D object is identified on the x-axis by the build material composition used to form the 3D object.

FIG. 5 shows that the elongation at break of the example 3D objects formed from the example build material compositions was greater than the elongation at break of the control 3D objects formed from the polyamide 12 (without plasticizer), and that the Young's Modulus of the example 3D objects formed from the example build material compositions was less than the Young's Modulus of the control 3D objects formed from the polyamide 12 (without plasticizer). FIG. 5 also shows that the ultimate tensile strength of the 3D objects formed from the example build material compositions and the ultimate tensile strength of the control 3D objects were comparable. Overall, these results indicate that the example plasticizers in the example build material compositions imparted ductility to the example 3D objects.

Further, FIG. 5 shows that the elongation at break of the example 3D objects formed from the first example build material composition was greater than the elongation at break of the example 3D objects formed from the second example build material composition, and that the Young's Modulus of the example 3D objects formed from the first example build material composition was less than the Young's Modulus of the example 3D objects formed from the second example build material composition. This indicates that the first example plasticizer imparted greater ductility to the example 3D objects than the second example plasticizer.

### Example 2

A comparative example of the build material composition was also prepared. The comparative build material included the polyamide 12 (VESTOSINT® Z2723 available from Evonik Degussa) and a comparative plasticizer. The comparative plasticizer was tosylamide (KETJENFLEX® 9S available from Akzo Chemie).

The comparative plasticizer was blended, at 8% loading, with the polyamide 12 to form the comparative build material composition. The mixing profile included: 800 rpm for about 30 seconds, 1200 rpm for about 50 seconds, and 800 rpm for about 30 seconds. The comparative mixture (including tosylamide) was then injection molded to form four different comparative (type 5) dogbones.

The ultimate tensile strength, elongation at break, and Young's Modulus of the comparative 3D objects were measured using Instron testing equipment. The average results of the comparative 3D objects are shown in FIG. 6. Also shown in FIG. 6 are the ultimate tensile strength, elongation at break, and Young's Modulus of the control 3D objects formed from the polyamide 12 (including no plasticizer, from Example 1) and the first example build material (including the first example plasticizer (having the formula (I), where n is 4 or 5), from Example 1). In FIG. 6, the ultimate tensile strength (in MPa, right axis), the elongation at break (in %, left axis), and the Young's Modulus (in MPa, left axis) are shown on the y-axes. Each 3D object is identified on the x-axis by the build material composition used to form the 3D object.

FIG. 6 shows that the elongation at break of the example 3D objects formed from the first example build material composition was greater than the elongation at break of the comparative 3D objects formed from the comparative build material composition, and that the Young's Modulus of the example 3D objects formed from the first example build material composition was less than the Young's Modulus of the comparative 3D objects formed from the comparative build material composition. FIG. 6 also shows that the ultimate tensile strength of the 3D objects formed from the first example build material composition and the second comparative build material composition were comparable. Overall, these results indicate that the first example plasticizer imparted greater ductility to the example 3D objects than the comparative plasticizer imparted to the comparative 3D objects.

It is to be understood that the ranges provided herein include the stated range and any value or sub-range within the stated range, as if such values or sub-ranges were explicitly recited. For example, from about 5 wt % to about 20 wt % should be interpreted to include not only the explicitly recited limits of from about 5 wt % to about 20 wt %, but also to include individual values, such as about 8.5 wt %, about 9.75 wt %, about 14.67 wt %, about 17.0 wt %, etc., and sub-ranges, such as from about 6.53 wt % to about 12.5 wt %, from about 10.25 wt % to about 16.2 wt %, from about 11.75 wt % to about 18.79 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A build material composition, comprising:
a polyamide; and
a plasticizer having:
a formula (I): 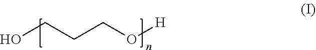
wherein n is an integer ranging from 3 to 8; or
a formula (II): 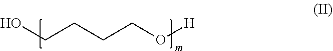
wherein m is an integer ranging from 3 to 8.

2. The build material composition as defined in claim 1 wherein the plasticizer is present in the build material composition in an amount ranging from about 5 wt % to about 20 wt %, based on the total weight of the build material composition.

3. The build material composition as defined in claim 1 wherein the polyamide is selected from the group consisting of polyamide 6 and polyamide 12.

4. The build material composition as defined in claim 1 wherein the plasticizer has the formula (I) and wherein n is 4 or 5.

5. The build material composition as defined in claim 1 wherein the plasticizer has the formula (II) and wherein m is 5.

6. A method for making the build material composition as defined in claim 1, comprising blending the polyamide with the plasticizer.

7. A three-dimensional (3D) printing kit, comprising:
a build material composition, including:
a polyamide; and
a plasticizer having:
a formula (I): 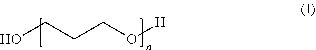
wherein n is an integer ranging from 3 to 8; or
a formula (II): 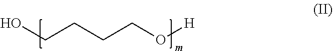
wherein m is an integer ranging from 3 to 8; and
a fusing agent to be applied to the at least the portion of the build material composition during 3D printing, the fusing agent including an energy absorber.

8. The 3D printing kit as defined in claim 7 wherein the fusing agent is a core fusing agent including an energy absorber having absorption at least at wavelengths ranging from 400 nm to 780 nm.

9. The 3D printing kit as defined in claim 8, further comprising a primer fusing agent including an energy absorber having absorption at wavelengths ranging from 800 nm to 4000 nm and has transparency at wavelengths ranging from 400 nm to 780 nm.

10. The 3D printing kit as defined in claim 7 wherein the fusing agent is a primer fusing agent including an energy absorber having absorption at wavelengths ranging from 800 nm to 4000 nm and has transparency at wavelengths ranging from 400 nm to 780 nm.

11. The 3D printing kit as defined in claim 7, further comprising a coloring agent selected from the group consisting of a black agent, a cyan agent, a magenta agent, and a yellow agent.

12. The 3D printing kit as defined in claim 7, further comprising a detailing agent including a surfactant, a co-solvent, and water.

13. A method for three-dimensional (3D) printing, comprising:
applying a build material composition to form a build material layer, the build material composition including:
a polyamide; and
a plasticizer having:
a formula (I): 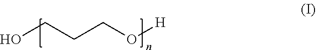
wherein n is an integer ranging from 3 to 8; or
a formula (II): 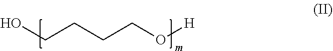
wherein m is an integer ranging from 3 to 8; and
forming a 3D object layer from at least a portion of the build material layer.

14. The method as defined in claim 13 wherein forming the 3D object layer includes:
selectively applying a fusing agent on the at least the portion of the build material layer; and
exposing the build material layer to electromagnetic radiation to coalesce the polyamide in the at least the portion.

15. The method as defined in claim 13 wherein forming the 3D object layer includes selectively exposing the at least the portion of the build material layer to a laser.
